(19) United States
(12) Patent Application Publication
(10) Pub. No.: US 2009/0166245 A1
(43) Pub. Date: Jul. 2, 2009

(54) COFFEE CADDY

(76) Inventor: Carl Cetera, Tenafly, NJ (US)

Correspondence Address: Steven E. Shapiro, 1223 Wilshire Blvd., #461, Santa Monica, CA, 90403, US

(21) Appl. No.: 11/967,932

(22) Filed: Dec. 31, 2007

(51) Int. Cl. B65D 1/36; B65D 85/00; B42D 15/00

(52) U.S. Cl. 206/562; 206/459.5; 283/67

(57) ABSTRACT

A coffee caddy for storing and organizing a plurality of coffee-serving supplies such as sugar packets, creamers, sweet and low, cups, stirring sticks, small sized napkins, and the like. The preferred embodiment of the coffee caddy has a base and a tray rotatably mounted thereupon. The tray has a planar bottom, an outer peripheral wall, and an inner pillar extending outwardly from the center of the tray. The pillar has a frusto-conically shaped upper portion so as to removably and inversely stack multiple cups thereupon. The tray further has a plurality of fan-shaped open compartments concentrically defined around the pillar for organizing and removably storing the coffee-serving supplies, and at least one of the compartments is sized and configured to store a plurality of coffee filters. The coffee caddy may further have advertising material disposed on any visible outer surface thereof.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates to field of a coffee caddy for organizing various coffee-serving supplies such as sugar packets, creamers, sweet and low, cups, stirring sticks, or the like.

Coffees have almost become one of the everyday necessities for many people. Therefore, it is now a common scene in living rooms, offices, kitchens of residential houses or work places that either a relatively small sized coffee maker or a larger coffee brewing machine occupies a corner. Often, various supplies needed for serving coffee and suiting the coffee to individual taste, such as sugar bags, creamers, sweet and low, disposable cups, stirring sticks, napkins, or in some cases instant coffee or tea bags as well, are placed next to the coffee maker. Commonly such supplies are kept in several trays or baskets, separately by their kinds, or just in a single tray or basket. Using several containers to separately contain different kinds of such supplies has drawbacks. It would not only require larger occupying space, but also make the surroundings of the coffee-making machine look messy. Using a single large tray to put in all kinds of supplies has its own drawbacks too. Then, the different kinds of supplies on the tray, even if they were initially sorted, would be easily mingled together to make it difficult to select a specific desired item and find out which specific kind runs short to need restock. These problems would impair not only the effectiveness in using, organizing, and managing those supplies, but also the aesthetics of the room and potentially the mood of people as well in enjoying a cup of coffee.

Therefore, there is a need to provide an organizer that is specifically designed for orderly holding various coffee-serving supplies, in which sugar bags, creamers, sweet and low, disposable cups, stirring sticks, or napkins are neatly and orderly sorted and kept in separate storages that are integrated in a single body to allow easy access for use and refill. Further, It would be desirable if such an organizer is structured, for example, to allow free rotation of the body containing the storages, so that a user may quickly and conveniently access to any individual storage as needed.

There are various organizers in the art, most of which are specifically designed for organizing desktop articles, kitchen wares, foods, or other kinds of small domestic articles. As such, those inventions are not structured to suit for coffee-serving supplies, especially, for storing fan-type disposable coffee filters or stirring sticks or straws, and thus have one or more shortcomings.

U.S. Pat. No. 4,775,055 discloses a condiment organizer having a rotatable tray that has an opening at a center for receiving a cylindrical container and a number of recessed pockets shaped to hold commercially sold spice containers of various shapes. This organizer is, however, inadequate for storing various coffee-serving supplies because there is no structure in the organizer that can hold multiple disposable cups stacked, for instance, upside down for easy removal. Further, being specifically designed for upholding commercial spice containers, the recessed pockets on the tray are not sized or shaped to store, for instance, plurality of stacked coffee filters or napkins.

U.S. Design Pat. No. D372,842 discloses a condiment caddy having a tray which defines several recessed condiment pockets and an inverse U-shaped grabbing handle affixed to the center for carrying the caddy thereby. U.S. Pat. No. 6,591,990 discloses a desktop organizer having a platform that has several recessed pockets for storing desktop items such as paperclips and two larger circular pockets for retaining a cylindrical pen container and a beverage container. But these inventions are also inadequate for organizing the coffee-serving supplies because they do not have any structure that can conveniently hold, for instance, multiple disposable cups stacked upside down or the commercially sold coffee-stirring sticks. Also, the recessed pockets in those inventions are not sized or shaped to store plurality of stacked coffee filters or napkins. Further, the tray or platform of those inventions is not rotatable.

In light of the limitations and shortcomings of prior art, it is desirable to provide an organizer that provides plurality of compartments that are specifically sized and configured to organize therein the common coffee-serving supplies such as sugar bags, creamers, sweet and low, disposable cups, stirring sticks, or even small sized napkins. It would be also desirable if such an organizer provides a mechanism that allows quick and convenient removal or restock of each kind of supplies as desired. It would be further desirable if such an organizer is aesthetically and compactly designed, and in addition, provides one or more surfaces to place advertising materials thereon for advertising or promotion.

### SUMMARY OF THE INVENTION

In accordance with a preferred embodiment of the present invention, there is provided an organizer, or a coffee caddy, that can hold a plurality of coffee-serving supplies such as sugar packets, creamers, sweet and low, cups, stirring sticks, small sized napkins, and the like.

The coffee caddy made in accordance with the present invention is largely comprised of: in the preferred embodiment, a substantially flat base and a tray rotatably mounted upon the flat base so that it can rotate freely relative to the base. The tray has a planar bottom, a circular outer peripheral wall, and an inner pillar extending outwardly from the center of the tray. The pillar is preferably integrally formed with the tray and has a frustoconical-shaped upper portion so as to removably stack multiple cups thereupon in inverted position. The tray further has a plurality of compartments concentrically arranged around the pillar for organizing and removably storing the coffee-serving supplies, one kind in each compartment. The plurality of compartments, preferably fan-shaped, are separated from one another by dividing walls radially extending from the pillar to the peripheral wall. The dividing walls may be either removable or integrally formed with the tray. In the preferred embodiment, at least one of the compartments is sized and configured to store a plurality of coffee filters.

The coffee caddy may also have advertising material or indicia imprinted on any visible outer surface of the caddy, including but not limited to, the outer surface of the circular peripheral wall or the pillar.

One of the advantages of the present invention is that, while having the capacity of organizing essentially all kinds of supplies commonly used for serving coffee, one can easily access to a particular kind of supplies since each kind is retained in a separate compartment on the tray.

Another advantage is that one can easily see at a glance that which particular kind of supplies runs shorts and thus needs restocking.

Yet another advantage of the present invention is that one can easily and conveniently remove a particular selected item of the supplies by simply rotating the tray on the base.

Still another advantage of the present invention is that by having all coffee-serving supplies organized in a single compact, aesthetically appeasing integrated unit, it helps not only save space and effectively serve coffee, but also cater to the aesthetic need of the chamber where it is located.

Lastly, the coffee caddy in the present invention has a further advantage that it can be used as an effective vehicle for advertisement by placing advertising material on any visible outer surface of the caddy, such as the outer surface of the pillar whose cute appearance is likely to attract the attention of a user.

### BRIEF DESCRIPTION OF THE DRAWINGS

FIG. 1 illustrates a perspective view of the coffee caddy made in the preferred embodiment of the present invention with coffee-serving supplies stored;

FIG. 2 illustrates a perspective view of the coffee caddy made in the preferred embodiment of the present invention without coffee-serving supplies;

FIG. 3 illustrates a top plan view of the coffee caddy made in the preferred embodiment of the present invention;

FIG. 4 illustrates a side elevational view of the coffee caddy made in the preferred embodiment of the present invention; and

FIG. 5 illustrates a cross-sectional side elevational view of the coffee caddy made in the preferred embodiment of the present invention.

### DETAILED DESCRIPTION OF THE PREFERRED EMBODIMENT

The preferred embodiment of the present invention will now be described with reference to figures (‘FIGS.’) 1-5, wherein like components are designated by like reference numerals throughout the figures. With regard to means for fastening, mounting, attaching or connecting the components of the present invention to form the assembly as a whole, unless specifically described otherwise, such means are intended to at least encompass conventional fasteners such as machine screws, machine threads, snap rings, hose clamps, rivets, nuts and bolts, toggles, pins and the like. Components may also be connected by friction fitting, snap fitting, adhesives or by welding or deformation, if appropriate. Unless specifically otherwise disclosed or taught, materials for making components of the present invention are selected from appropriate materials such as metal, ceramics, metallic alloys, natural or synthetic fibers, plastics and the like, and appropriate manufacturing or production methods including casting, extruding, injection molding and machines may be used.

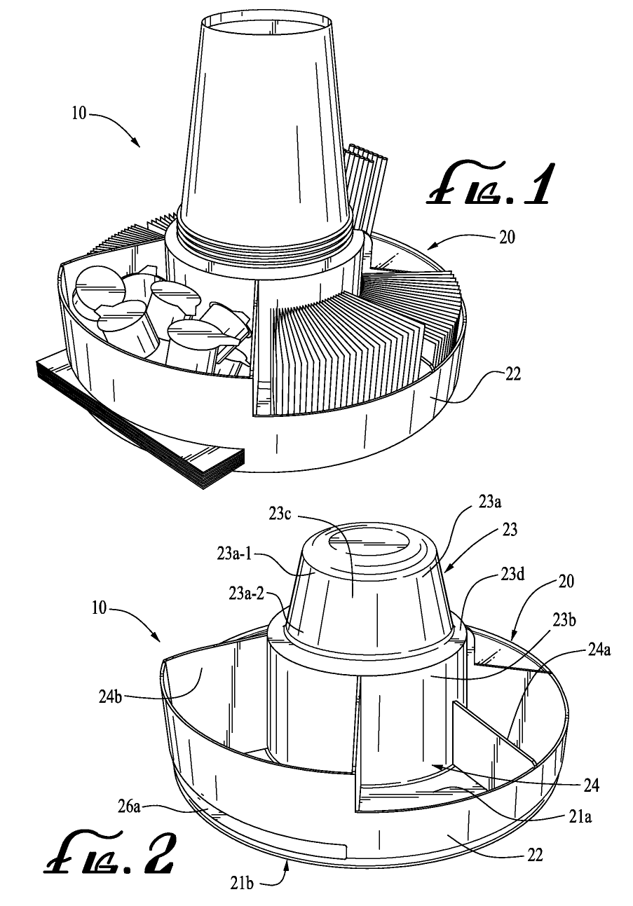

Referring now to the drawings wherein the showings are for purposes of illustrating preferred embodiments of the present invention only, and not for purposes of limiting the same, in FIGS. 1-5, a preferred embodiment of the coffee caddy 10 in the present invention comprises largely a tray 20 and a base 30.

The tray 20 has substantially planar, identically sized and configured, and paralley disposed first and second bottoms 21a, 21b, respectively, and a peripheral wall 22 extending perpendicularly upward from the edge of the second bottom 21b past the edge of the first bottom 21a. In the preferred embodiment, the first and second bottoms 21a and 21b and the peripheral wall 22 are circular, but in other embodiments, they may have polygonal shapes such as rectangle, octagon, hexagon, etc.

Between the first and second bottoms 21a, 21b is defined a storage bin 26 for holding a plurality of napkins therein. The storage bin 26 is accessible through an elongated opening 26a defined on the peripheral wall 22 for stocking and removing the napkins. The storage bin 26 is sized, preferably, to retain a plurality of napkins each of which has a dimension of at least 5 inches by 5 inches.

The tray 20 further has a pillar 23 protruding perpendicularly upward from the center of the first bottom 21a. The pillar 23 may be integrally formed with the first bottom 21a or molded as a separate piece and attached thereto by any attachment means known in the art, such as adhesives. In the preferred embodiment, the pillar 23 has two portions, an upper portion 23a and lower portion 23b. The upper portion 23a in the preferred embodiment has a frusto-conical shape, that is, the shape of a cone truncated at the top, which therefore has a top having a smaller diameter than the bottom. Such particular shape of the upper portion 23a has several advantages over other shapes in retaining multiple cups upside down. One advantage is that the sloped side surface of the pillar provides securer retention of the cups stacked thereupon by having the mouth of the cups frictionally retained against it. If the pillar is shaped as a straight cylinder, for example, one can consider two situations. If the inner bottom of the cup to be inversely retained on the pillar has a bigger diameter than the pillar, the cup would be dangling over the pillar with the inner bottom of the cup pressed against the top of the pillar. If the inner bottom of the cup has a smaller diameter than the pillar, then the top edge of the pillar will be pressed upon somewhere in the middle of the inner surface of the cup with the mouth of the cup agape downward. In either case, the retention of the cup would not be as tight and secure as in the present case where the frusto-conical pillar is used. Another advantage of the particular shape of the pillar in the present invention is that it permits retention of multiple cups of various sizes. Owing to the sloped side surface of the frusto-conical pillar, cups of different mouth sizes can be retained upon the pillar with the mouths, still being tightly pressed against different portions of the side surface depending on their respective mouth sizes.

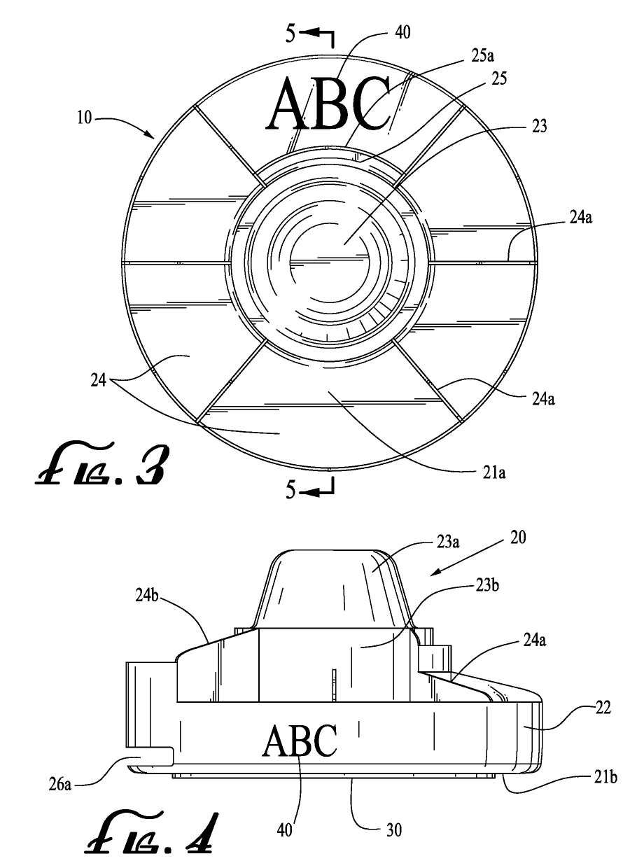

These advantages are, in fact, not limited to the particular frusto-conical shape employed in the preferred embodiment. The same advantages will be obtained from other shapes as well as long as the upper portion of the pillar has a first portion and a contiguous second portion, closer to the bottom of the pillar than the first portion, wherein the second portion is wider than the first portion to define a generally sloped side surface therewith. FIG. 2 shows such a first portion 23a-1, a second portion 23a-2, and the sloped side surface 23c in the particular case of the preferred embodiment. The side surface may be rounded, as in the preferred embodiment, for enhanced engagement with the round mouth of ordinary cups, but such roundness of the side surface is not essential to the invention. The present invention therefore contemplates a caddy with a pillar with an upper portion that has a generally increasing width as it goes from the first portion to the second portion of the upper portion. For example, a pillar having an upper portion with a shape of an inverted half-sphere would fall within the design contemplated by the present invention.

The lower portion 23b, which may be integrally formed with the upper portion 23a, has preferably a cylindrical shape whose upper end has a slightly greater diameter than the lower end of the upper portion 23a so as to form a neck 23d, shown in FIG. 2, at their junction. When a plurality of cups is stacked upon the upper portion 23a upside down, the neck 23d provides a rest for the mouths of the stacked cups.

The tray 20 defines a plurality of open compartments 24 upon the first bottom 21a, which are, preferably, concentrically arranged around the pillar 23. In the preferred embodiment, each of the compartments 24 has a generally truncated fan shape defined by part of the lower portion 23b of pillar 23, part of the peripheral wall 22, and two thin dividing walls 24a radially extending from the lower portion 23b of the pillar 23 to the peripheral wall 22. In each compartment 24, a user can store and organize different kind of coffee-serving supplies such as sugar packets, instant coffee bags, tea bags, creamers, or even small napkins. Particularly, in the preferred embodiment one of the compartments 24 is large enough to retain a plurality of commonly used disposable coffee filters, which are preferably vertically stacked as shown in FIG. 1. The truncated fan shape of the compartment would be particularly advantageous in vertically stacking coffee filters having a similar shape of a truncated fan, most of commercially available coffee filters. Also, as shown in FIGS. 1, 2, and 4, at least one of the compartments has dividing walls 24b of a larger height than the rest of the dividing walls 24a to provide a greater storage capacity. Such a larger compartment could be used for storing, for instance, a plurality of rather bulky supplies such as liquid cream cubes. The dividing walls 24a may be integrally formed with the tray 20 or detachable and repositionable for rearranging the relative sizes of the compartments 24 as desired.

In the preferred embodiment, the tray 20 may further define, preferably upon the second bottom 21b and around the lower portion 23b of the pillar 23, an additional narrow arcuate compartment 25. Being formed upon the second bottom 21b, the compartment 25 has a greater depth than other compartments 24 and thus suits for storing elongated coffee-stirring sticks therein. Radially outward the compartment 25, is positioned at least one of the compartments 24 separated by a thin arcuate wall 25a. Preferably, the arcuate wall 25a angularly extends from the center of the tray 20 at an angle of at least 30 degrees.

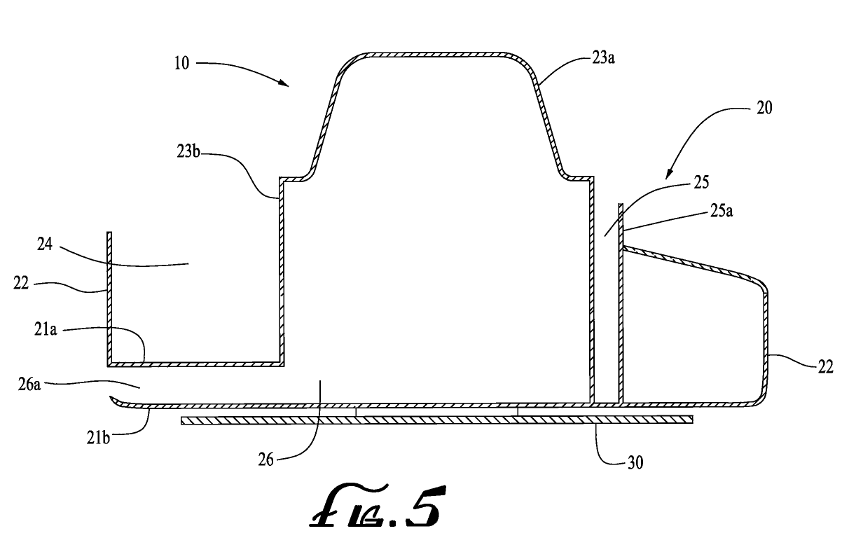

Also, in the preferred embodiment, in order to facilitate easy access and removal of a particular coffee-serving item needed, the tray 20 is rotatably mounted upon the thin flat base 30 such that the tray may rotate freely or unobstructively. Such rotational connection is achieved in the preferred embodiment by rotatably connecting the center of the second bottom 21b of the tray 20 to the center of a thin flat base 30 as shown in FIGS. 4 and 5 so that the tray 20 may freely rotate about an axis through the respective centers. The method and means for such rotational connection are well known to those skilled in the art and not described herein further.

The tray 20, including the pillar 23 and dividing walls 24a, 24b, 25a, and the base 30 are fabricated of, preferably, plastics, ceramics, or polymeric compositions, but may be made of any rigid suitable material known to those in the art, including but not limited to, wood, metal, cardboard, synthetic fibers, fiberglass, hardboard, or the like, by using appropriate manufacturing or production methods such as casting, extruding, injection molding or other currently known means readily recognized by one skilled in the art.

Since the coffee caddy in the present invention would be more likely to attract attentions of the user and other viewers owing to its compact, unique, and aesthetically appeasing appearance, it can be an effective vehicle for advertisement. Advertising material or indicia 40 may be disposed on the outer surface of the pillar 23, the peripheral wall 22 as shown in FIG. 4, or on any other visible surfaces of the caddy such as a lid covering one of the compartments 24 as shown in FIG. 3. Such advertising material may include, but not be limited to, a logo, trademark, advertisement, emblem, label, stamp, feature, brand, insignia, crest, token, seal, decal, pitch, announcement, slogan, monogram. The advertising indicia need not be limited to letters or words, but can be also a photo, design, or other pictorial representation. The advertising material may be in one embodiment directly imprinted on those surfaces, or in another embodiment, it may be printed on a piece of paper, which is then permanently or replaceably attached to the surfaces. A protective transparent plastic cover may be further placed upon such advertising material.

Accordingly, the present invention also includes a method of advertising using the coffee caddy made according to the invention. Such an advertising method comprises the steps of providing a coffee caddy made according to the present invention, and disposing advertising indicia on an external visible surface of the caddy. The term “providing” is meant in a broad sense to include not only manufacturing but also acquiring from another source or selecting from available supplies. The term “disposing” is meant broadly to encompass any means known to one skilled in the art for physically putting the advertising indicia on the device's surface, including but not limited to, imprinting, engraving, adhering, etc.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

1. A coffee caddy for storing and organizing a plurality of packets, a plurality of cups, and a plurality of coffee filters, the caddy comprising:
a substantially flat base; and
a tray rotatably mounted upon the flat base so as to rotate unobstructively relative thereto, the tray having a planar bottom, an outer peripheral wall extending therefrom, and an integrally formed inner pillar outwardly extending from a center of the tray substantially perpendicularly with respect to the planar bottom for inversely and removably stacking the cups thereupon, the pillar comprising an upper portion having first and second portions connected to and integrally formed with each other to form a continuous side surface therewith, the second portion being closer to the planar bottom than the first portion, the second portion having a larger width than the first portion, the tray further defining a plurality of open compartments concentrically arranged around the pillar for organizing and removably storing the sugar packets therein, the plurality of compartments being separated from one another by dividing walls extending radially from the pillar toward the peripheral wall, wherein at least one of the plurality of compartments is sized and configured to store the coffee filters therein.

2. The coffee caddy in claim 1, wherein the peripheral wall of the tray is substantially circular and each of the plurality of compartments has a shape of a truncated fan.

3. The coffee caddy in claim 1, wherein the side surface of the upper portion is rounded to define a circular cross-section when cut in parallel to the planar bottom.

4. The coffee caddy in claim 3, wherein the cross-section of the second portion has a greater diameter than the cross-section of the first portion.

5. The coffee caddy in claim 1, wherein the number of the plurality of compartments is at least 5.

6. The coffee caddy in claim 1, wherein the radial dividing walls are removable from the tray and repositionable for rearranging relative sizes of the plurality of the compartments.

7. The coffee caddy in claim 1, wherein the tray further comprises an arc-shaped open compartment formed upon the planar bottom and annularly around the pillar for storing a plurality of stirring sticks therein.

8. The coffee caddy in claim 1, wherein at least one of the compartments are bounded by dividing walls of a greater height than the rest of the dividing walls.

9. The coffee caddy in claim 1, wherein the tray further defines an elongated opening on the peripheral wall that extends under at least one of the compartments to form a storage bin, the storage bin being sized and configured to retain a plurality of napkins, each having a dimension of at least 5 by 5 inches.

10. The coffee caddy in claim 1, wherein the pillar further comprising a substantially cylindrical lower portion integrally formed with the second portion of the upper portion, the lower portion having a larger cross-sectional area than the second portion to define a neck at the junction therebetween for providing a resting surface for the mouths of the cups inversely stacked upon the upper portion.

11. The coffee caddy in claim 8, wherein the dividing walls extend from, and are integrally form with, the lower portion.

12. The coffee caddy in claim 1, further comprising advertising material disposed upon an outer surface of the caddy.

13. The coffee caddy in claim 1, wherein the planar bottom of the tray and the base are rotatably connected at respective centers thereof to rotate about an axis therethrough.

14. A coffee caddy for storing and organizing a plurality of packets, a plurality of cups, and a plurality of coffee filters, the caddy comprising:
a substantially flat base; and
a tray rotatably mounted upon the flat base so as to rotate unobstructively relative thereto, the tray having a planar bottom, an outer peripheral wall extending therefrom, and an integrally formed inner pillar outwardly extending from a center of the tray substantially perpendicularly with respect to the planar bottom, the pillar comprising an upper portion defining a frusto-conical shape for inversely and removably stacking the cups thereupon, the tray further defining a plurality of open compartments concentrically arranged around the pillar for organizing and removably storing the sugar packets therein, the plurality of compartments being separated from one another by dividing walls extending radially from the pillar toward the peripheral wall, wherein at least one of the plurality of compartments is sized and configured to store the coffee filters therein.

15. The coffee caddy in claim 14, wherein the peripheral wall of the tray is substantially circular and each of the plurality of compartments has a shape of a truncated fan.

16. The coffee caddy in claim 14, wherein the number of the plurality of compartments is at least 5.

17. The coffee caddy in claim 14, wherein the radial dividing walls are formed separately from the tray and configured to be both removable and repositionable for rearranging relative sizes of the plurality of the compartments.

18. The coffee caddy in claim 14, wherein the tray further comprises an arc-shaped open compartment formed upon the planar bottom and annularly around the pillar for storing a plurality of stirring sticks therein.

19. The coffee caddy in claim 14, wherein at least one of the compartments are bounded by dividing walls of a greater height than the rest of the dividing walls.

20. The coffee caddy in claim 14, wherein the tray further defines an elongated opening on the peripheral wall that extends under at least one of the compartments to form a storage bin, the storage bin being sized and configured to retain a plurality of napkins, each having a dimension of at least 5 by 5 inches.

21. The coffee caddy in claim 14, wherein the pillar further comprising a substantially cylindrical lower portion integrally formed with the frusto-conical upper portion, the lower portion having a larger diameter than the bottom of the upper portion to define a neck at the junction therebetween for providing a resting surface for the mouths of the cups inversely stacked upon the upper portion.

22. The coffee caddy in claim 21, wherein the dividing walls extend from, and are integrally form with, the lower portion.

23. The coffee caddy in claim 14, further comprising advertising material disposed upon an outer surface of the caddy.

24. The coffee caddy in claim 14, wherein the planar bottom of the tray and the base are rotatably connected at respective centers thereof to rotate about an axis therethrough.

25. A method of advertising comprising the steps of:
a) providing a coffee caddy for storing and organizing a plurality of packets, a plurality of cups, and a plurality of coffee filters, the caddy comprising:
a substantially flat base, and
a tray rotatably mounted upon the flat base so as to rotate unobstructively relative thereto, the tray having a planar bottom, an outer peripheral wall extending therefrom, and an integrally formed inner pillar outwardly extending from a center of the tray substantially perpendicularly with respect to the planar bottom for inversely and removably stacking the cups thereupon, the pillar comprising an upper portion having first and second portions connected to and integrally formed with each other to form a continuous side surface therewith, the second portion being closer to the planar bottom than the first portion, the second portion having a larger width than the first portion, the tray further defining a plurality of open compartments concentrically arranged around the pillar for organizing and removably storing the sugar packets therein, the plurality of compartments being separated from one another by dividing walls extending radially from the pillar toward the peripheral wall, wherein at least one of the plurality of compartments is sized and configured to store the coffee filters therein; and
b) disposing advertising material on a visible outer surface of the coffee caddy.
